(19) United States
(12) Patent Application Publication
(10) Pub. No.: US 2018/0044758 A1
(43) Pub. Date: Feb. 15, 2018

(54) DEVICE FOR HEATING IRON AND STEEL PRODUCTS, AND METHOD FOR HEATING IRON AND STEEL PRODUCTS

(71) Applicants: TAIYO NIPPON SANSO CORPORATION, Tokyo (JP); NISSHIN STEEL CO., LTD., Tokyo (JP)

(72) Inventors: Yasuyuki YAMAMOTO, Tokyo (JP); Kimio IINO, Tokyo (JP); Shinichi KOGA, Osaka (JP)

(21) Appl. No.: 15/557,586

(22) PCT Filed: Mar. 25, 2016
(86) PCT No.: PCT/JP2016/059695

§ 371 Date: Sep. 12, 2017

(30) Foreign Application Priority Data
Mar. 26, 2015 (JP) 2015-065015

(51) Int. Cl. C21D 9/56; F27D 17/00; F27B 9/36; F27D 7/02; C21D 1/52; F27B 9/12

(52) U.S. Cl. CPC C21D 9/56; C21D 1/52; F27B 9/12; F27B 9/36; F27D 7/02; F27D 17/001; F27B 2009/3638

(57) ABSTRACT

A device for heating an iron and steel product (steel product), the device including: a preheating chamber for preheating the steel product; a heating chamber for heating the steel product to a desired temperature which is connected to the preheating chamber; a plurality of burners arranged so as to sandwich the steel product from above and below in the heating chamber; and a means for causing an exhaust gas containing combustion gas in the burners to flow into the preheating chamber, wherein the burners form flames with a fuel and an oxidizing agent having an oxygen concentration of 80 vol % or more and have a function of blowing away fats and oils adhered onto the surface of the steel product by the flames, and the preheating chamber has a structure for preheating the steel product by an exhaust gas which has been made to flow thereinto by the means.

### TECHNICAL FIELD

The present nvention relates to a device for heating an iron and steel product (steel product) formed by cold rolling and a method for heating an iron and steel product (steel product).

Priority is claimed on Japanese Patent Application No. 2015-065015, filed Mar. 26, 2015, the content of which is incorporated herein by reference.

### BACKGROUND ART

In general, when a product manufactured by cold rolling is subjected to a plating treatment or the like, after heating to about 500° C. in a very large heating furnace having a furnace length of, for example, several tens of meters, the resultant is heated and annealed to about 800° C. in an annealing furnace. In the case of this method, since the furnace length is very long, the heat loss of a furnace body is large and the thermal efficiency is poor. It should be noted that cold rolling refers to a rolling process performed without heating a metal, and rolling refers to a process in which two or more rollers are rotated and a metal is passed through therebetween so as to be processed into the shape of a plate, a bar, a tube or the like.

In addition, in products manufactured by cold rolling, since fats and oils and organic particles and inorganic particles mixed in fats and oils adhere onto the surface of the products to cause quality problems in plating and other proe,esses, it is necessary to remove these deposits in advance.

In the case of a direct-firing type heating furnace, although the oil content is burnt and removed in the heating furnace, since it is heated in a very large heating furnace as described above, the furnace wall heat loss and the heat loss by water cooling of a conveying roller or the like are large, and the thermal efficiency is poor.

Further, in the case of a radiant-tube type heating furnace (indirect heating), since the oil content cannot be burnt and removed, it is necessary to remove it using a solvent before being placed in the heating furnace. For this reason, as a result of adding a washing step, the process line becomes longer, and it is also necessary to treat the solvent used in the washing step, which are expensive.

As an example of a direct-firing type heating device, a heating device as disclosed in Patent Document 1 has been known. In this heating device, a burner is installed in parallel to the object to be heated, and the object to be heated is indirectly heated mainly by the radiant heat from the flame.

However, since it was indirectly heated by the radiant heat from the flame, it was necessary to enlarge the furnace body, and the thermal efficiency was poor.

In addition, as another example of a direct-firing type heating device, a heating device as disclosed in Patent Document 2 has been known. Since this heating device heats the object to be heated by collision with a flame, the heat transfer efficiency was higher than that of the heating device disclosed in Patent Document 1.

### CITATION LIST

### Patent Documents

[Patent Document 1] Japanese Unexamined Patent Application, First Publication No. 2006-284019

[Patent Document 2] Japanese Unexamined Utility Model Application, First

Publication No. Hei 5-37954

### SUMMARY OF INVENTION

### Technical Problem

Incidentally, since the burner installed in the direct-firing type heating device for heating the steel product formed by cold rolling burns a fuel with air, the flame temperature was at most about 1,800° C.

In addition, because the burning speed is slow, it was difficult to form a high speed flame from the problem of flame blow oft For this reason, even with a type of heating device that makes a flame to collide, there was a limit for rapidly heating a steel product.

The present invention has been made in consideration of such circumstances, and an object thereof is to provide a device for heating an iron and steel product (steel product) and a method for heating a steel product that can efficiently and rapidly heat a steel product manufactured by cold rolling acrd can also remove adhered fats and oils as well as organic particles and inorganic particles mixed in fats and oils.

### Solution to Problem

Accordingly, in order to solve the above problems, the present invention employs the following configurations.

(1) A device for heating an iron and steel product which is formed by cold rolling, the device including:

a preheating chamber for eheating the aforementioned steel product;

a heating chamber for heating the aforementioned steel product to a desired temperature which is connected to the aforementioned preheating chamber;

a plurality of burners arranged so as to sandwich the aforementioned steel product from above and below in the aforementioned heating chamber; and

an exhaust gas discharge unit for discharging an exhaust gas containing combustion gas in the aforementioned burners to the outside of the aforementioned heating device after being flown into the aforementioned preheating chamber,

wherein the aforementioned burners form flames with a fuel and an oxidizing agent having an oxygen concentration of 80 vol % or more and have a function of blowing while burning, at least one of fats and oils adhered onto a surface of the aforementioned steel product and inorganic particles and organic particles mixed in the aforementioned fats and oils by the aforementioned flame, and

the aforementioned preheating chamber has a structure for preheating the aforementioned steel product by an exhaust gas containing combustion gas in the aforementioned burners which has been made to flow thereinto by the aforementioned exhaust gas discharge unit.

(2) The device for heating a steel product according to the above (1), wherein when a combustion amount per one of the aforementioned burners is Q [Mcal/h],

a distance H between a tip of the aforementioned burner and the aforementioned steel product is set in a range from (30 to 110)×Q^{(1/3)} mm, and an angle α formed between the central axis of the aforementioned burner and the surface of the aforementioned steel product is set in a range of 60 to 90 degrees.

(3) The device for heating a steel product according to the above (1) or (2),

wherein a plurality of the aforementioned burners on an upper side of the aforementioned steel product and/or the aforementioned burners on a lower side of the aforementioned steel product are arranged in one row, and

when a combustion amount per one of the aforementioned burners is Q [Mcal/h], an interval d between the plurality of the aforementioned burners arranged in the one row is in a range of (7 to 20)×Q^{(1/2)} mm.

(4) The device for heating a steel product according to any one of the above (1) to (3),

wherein the aforementioned burners on an upper side of the aforementioned steel product and/or the aforementioned burners on a. lower side of the aforementioned steel product are arranged so as to form two or more burner rows, and

when a combustion amount per one of the aforementioned burners is Q [Mcal/h], an interval L between the aforementioned burner rows is in a range of (17 to 300)×Q ^{(1/2)} mm.

(5) The device for heating a steel product according to the above (4),

wherein the aforementioned interval L between the aforementioned burner rows is set to a range of (17 to 68)×Q^{(1/2)} mm or a range of (100 to 300)×Q^{(1/2)} mm.

(6) The device for heating a steel product according to the above (4) or (5),

wherein the aforementioned burners arranged to form two or more burner rows are alternately arranged.

(7) A method for heating a steel product which is formed by cold rolling where the aforementioned steel product is heated in a preheating chamber, then introduced into a heating chamber connected to the aforementioned preheating chamber and heated to a desired temperature,

wherein a plurality of burners arranged so as to sandwich the aforementioned steel product from above and below are provided in the aforementioned heating chamber,

the aforementioned steel product is heated by causing flames formed by the aforementioned burners using a fuel and an oxidizing agent having an oxygen concentration of 80 vol % or more to directly collide with a surface of the aforementioned steel product, and

at the same time at least one of fats and oils adhered onto a surface of the aforementioned steel product and inorganic particles arid organic particles mixed in the aforementioned fats and oils is blown away, while being burnt, by the aforementioned flames, and

an exhaust gas containing the combustion gas in the aforementioned burner is introduced into the aforementioned preheating chamber, thereby exchanging heat with the aforementioned steel product.

(8) The method for heating a steel product according to the above (7),

wherein a flow rate of the aforementioned oxidizing agent supplied to the aforementioned burner is in a range of 90 to 120% of a flow rate of oxygen necessary for completely burning the aforementioned fuel.

(9) The method for heating a steel product according to the above (7) or (8),

wherein when a combustion amount per one of the aforementioned burners is [Mcal/h], a distance H between a tip of the aforementioned burner and the aforementioned steel product is set in a range from (30 to 100)×Q^{(1/3)} mm, and

an angle α formed between the central axis of the aforementioned burner and the surface of the aforementioned steel product is set in a range of 60 to 90 degrees.

(10) The method for heating a steel product according to any one of the above (7)to (9),

wherein a plurality of the aforementioned burners on an upper side of the aforementioned steel product and/or the aforementioned burners on a lower side of the aforementioned steel product are arranged in one row, and

when a combustion amount per one of the aforementioned burners is Q [Mcal/h], an interval d between the plurality of the aforementioned burners arranged in the one row is in a range of (7 to 20)×Q^{(1/2)} mm.

(11)The method for heating a steel product according to any one of the above (7) to (10),

wherein the aforementioned burners on an upper side of the aforementioned steel product and/or the aforementioned burners on a lowerside of the aforementioned steel product are arranged so as to form two or more burner rows, and

when a combustion amount per one of the aforementioned burners is Q [Mcal/h], an interval L between the aforementioned burner rows is in a range of (17 to 300)×Q ^{(1/2)} mm.

(12) The r etl od for heating a steel product according to the above (11), wherein the aforementioned interval L between the aforementioned burner rows is set to a range of (17 to 68)×Q^{(1/2)} mm or a range of (100 to 300)×Q^{(1/2)} mm.

(13) The method for heating a steel product according to any one of the above (7) to (12), wherein the combustion amount per one of the aforementioned burners is in a range of 10 to 100 Mcal/h.

### Advantageous Effects of Invention

According to the present invention,it is possible to efficiently and rapidly heat a product manufactured cold rolling and to remove adhered fats and oils as well as organic particles and inorganic particles mixed in fats and oils.

### BRIEF DESCRIPTION OF DRAWINGS

FIG. 1 is a cross-sectional view showing a heating device according to an embodiment of the present invention.

FIG. 2 is a perspective view showing a part of a heating device according to an embodiment of the present invention.

FIG. 3 is a cross-sectional view showing a part of a heating device according to an embodiment of the present invention.

FIG. 4 is a plan view showing a part of a heating device according to an embodiment of the present invention.

FIG. 5 is a graph showing the temperature deviation of the steel plate temperature at each point in the width direction of a steel plate with respect to the burner interval in an example of the present invention.

FIG. 6 is a graph showing a relationship between the distance between rows of burners (burner row distance) and the relative heat transfer efficiency in an example of the present invention. FIG. 7 is an explanatory diagram with regard to a method of evaluatingthe amount of carbon remaining on the surface of a degreased test piece.

### DESCRIPTION OF EMBODIMENTS

Hereinafter, a device for heating an iron and steel product (steel product) and a method for heating an iron and steel product (steel product) which is an embodiment employing the present invention will be described.

### <Heating Device>

First, a device for heating a steel product according to the present embodiment will be described.

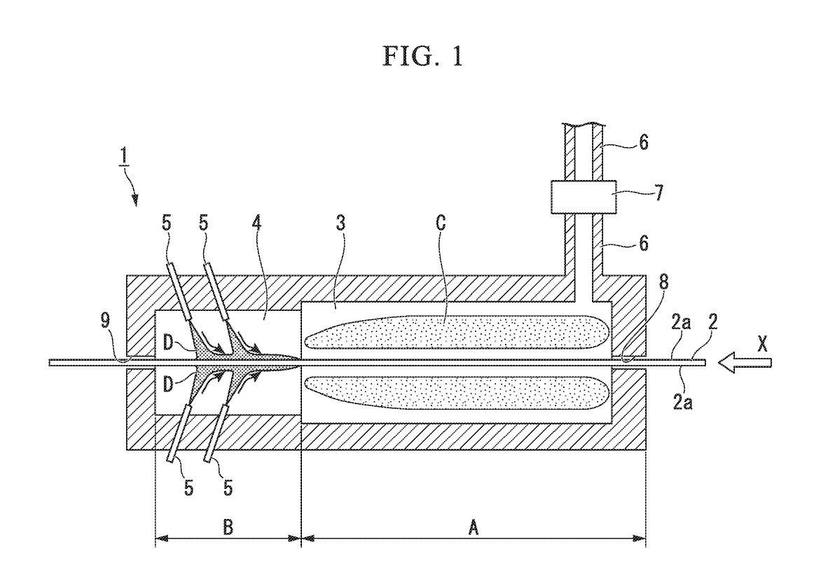

As shown in FIG. 1, a heating device 1 for a steel product (steel plate) of the present embodiment is a device for heating a steel plate 2 which is a steel product formed by cold rolling, and includes a preheating chamber 3 for preheating the steel plate 2, a heating chamber 4 connected to the preheating chamber 3, a plurality of burners 5 provided in the heating chamber 4. an exhaust gas discharge pipe 6 connected to the preheating chamber 3, and an exhaust gas discharge unit 7 provided in the exhaust gas discharge pipe 6.

FIG. 1 is a cross-sectional view showing a schematic configuration of the heating device 1 of the present embodiment. Further, in FIGS. 1 to 4, an arrow X indicates a moving direction of the steel plate 2.

The preheating chamber 3 is a part that receives the steel plate 2 first in the heating device 1 and is a preheating portion A for preheating the steel plate 2. The preheating chamber 3 is provided with a steel plate inlet 8 for charging the steel plate 2 on the upstream side in the moving direction X of the steel plate 2 (hereinafter simply referred to as “upstream side”), and a downstream side in the moving direction X of the steel plate 2 (hereinafter simply referred to as “downstream side”) is connected to the heating chamber 4.

The furnace length (the length in the X direction) of the preheating chamber 3 is preferably designed to be in a range of 0.5 to 4 in, and more preferably designed to be in a range of 1 to 4 m. Even if it is longer than 4 in. the heating efficiency of the steel plate hardly changes, and there is a disadvantage in that the equipment becomes unnecessarily large and the equipment cost becomes high. When it is shorter than 0.5 m, the heat quantity of the exhaust gas of the heating device 1 cannot be recovered, and there is a disadvantage in that the heat loss of the exhaust gas increases.

Further, the exhaust gas discharge pipe 6 for discharging an exhaust gas C is connected to the upstream side of the preheating chamber 3, and the exhaust gas discharge unit 7 for discharging the exhaust gas C such as a blower is provided in the exhaust gas discharge pipe 6.

By operating the exhaust gas discharge unit 7 and drawing the gas in the preheating chamber 3 and the heating chamber 4 through the exhaust gas discharge pipe 6, the exhaust gas C containing the combustion gas of the burner 5 can be made to flow into the preheating chamber 3 from the heating chamber 4 and then discharged to the outside of the heating device 1 through the exhaust gas discharge pipe 6.

As described above, the preheating chamber 3 has a structure for preheating the steel plate 2 by exchanging heat between the exhaust gas C containing the combustion gas in the burner 5 flown in from the heating chamber 4, by the exhaust gas discharge unit 7, and the steel plate 2.

The heating chamber 4 is a heating portion B for heating the steel plate 2 to a desired temperature, and its upstream side is connected to the preheating chamber 3, while a steel plate outlet 9 for taking out the steel plate is provided on the downstream side.

The furnace length (the length in the X direction) of this heating chamber 4 is preferably in a range such that it is greater than the sum of intervals L of a burner row E which will be described later by 0.5 to 1.5 m. If it is longer by more than 1.5 m. the heating chamber 4 becomes large to cause heat loss of the furnace body, and if it is longer by less than 0.5 m, the load of the combustion chamber of the heating portion decreases and the heat transfer efficiency decreases, which is disadvantageous. In addition, in the heating chamber 4, a plurality of burners 5 are provided so as to sandwich the steel plate 2 from above and below.

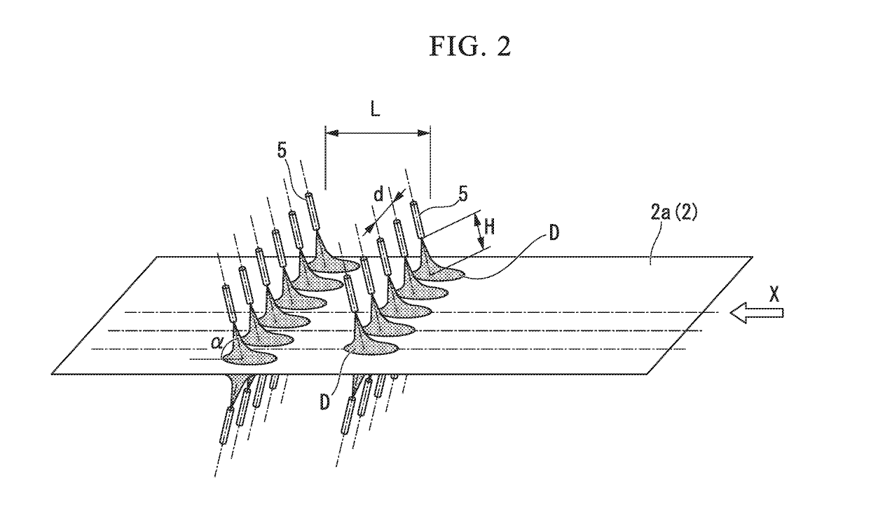

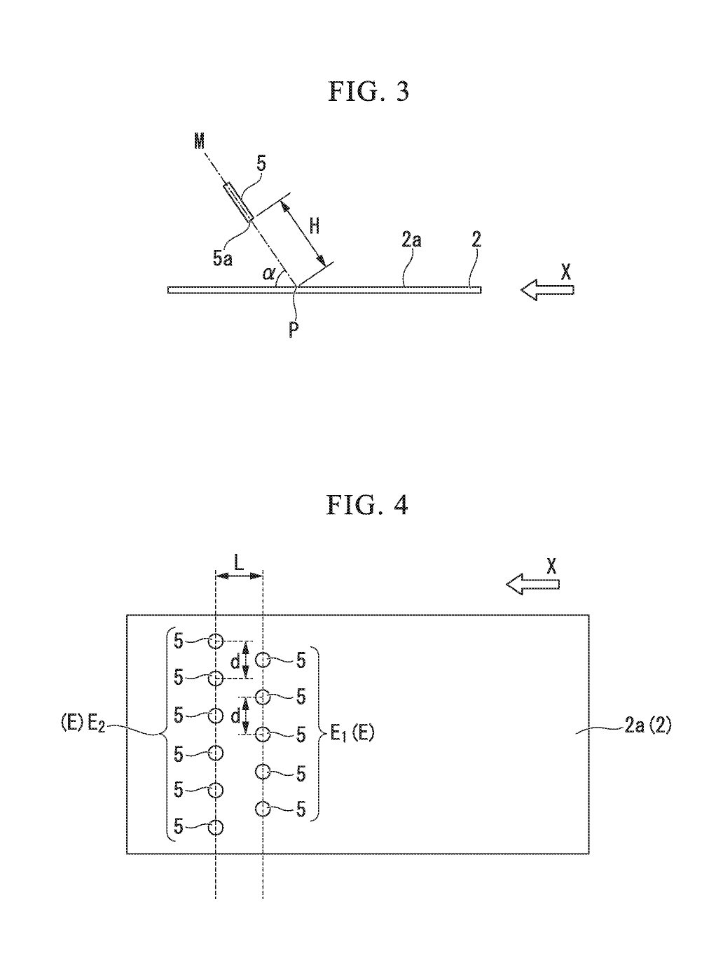

The burners 5 form flames D with a fuel and an oxidizing agent having an oxygen concentration of 80 vol % or more, more preferably 90 vol % or more, Further, as shown in FIGS. 2 and 3, the burners 5 are disposed at such positions that the flames D collide directly with a surface 2a of the steel plate 2.

FIG. 2 is a perspective view in which the outer wall of the heating chamber 4 is omitted, and FIG. 3 is a cross-sectional view showing only the steel plate 2 and the burner 5.

More specifically, a distance H from a tip 5a of the burner 5 to the steel plate 2 is preferably in a range of (30 to 110)×Q^{(1/3)} mm, and more preferably in a range of (60 to 110)×Q^{(1/3)} mm, when Q [Mcal/h] is a combustion amount per one burner 5. For example, if the combustion amount is 35 Mcal/h, it is more preferable to set the distance H in a range of approximately 200 to 360 mm.

If it is shorter than 30×Q^{(1/3)} mm, there is a high possibility of damaging the burner 5 due to rebounding of the flame D, and if it is longer than 110×Q^{(1/3)} mm, the flow rate and temperature at the time the flame D collides with the steel plate 2 decrease, and high heat transfer efficiency cannot be obtained.

As shown in FIG. 3, the distance H from the tip 5a of the burner 5 to the steel plate 2 is a distance from the tip 5a of the burner 5 to an intersection P between the central axis M of the burner and the surface 2a of the steel plate 2.

Further, it is preferable that an angle α formed between the centralaxis M of the burner 5 and the surface 2a of the steel plate 2 be in a range of 60 to 90 degrees, so that the direction of the flame D of the burner 5 (that is, the direction of the burn set to be perpendicular to the moving direction X of the steel plate 2, or opposed thereto.

When the angle α is smaller than 60 degrees, the heat transfer efficiency decreases, and when. the angle α is larger than 90 degrees, the decrease in the heat transfer effect also becomes significant in a similar manner.

Further, although the angle α formed by the central axis M of the burner 5 and the surface 2a of the steel plate 2 may be different for each of the burners 5, in order to uniformly heat the steel plate 2, it is preferable that all the burners 5 be provided at the same angle.

In addition, in the present embodiment, as shown in FIGS. 2 and 4, a burner row E is formed by a plurality of burners 5 provided in a direction perpendicular to the moving direction X of the steel plate 2.

FIG. 4 is a plan view showing only the burners 5 and the steel plate 2.

An interval d between the burners 5 constituting each burner row E is preferably in a range of (to 25)×Q^{(1/2)} mm, and more preferably in a range of (7 to 20)×Q^{(1/2)} mm. For example, when the combustion amount is 35 Mcal/h, it is more preferable to set the interval d in a range of approximately 40 to 120 mm.

When the interval d of the burner 5 is shorter than 5×Q^{(1/2)} mm, it is necessary to provide a very large number of burners 5 when heating steel plate 2 or the like, which is not practical. In addition, when the interval d of the burner 5 is longer than 25 ×Q^{(1/2)} mm, it is difficult to uniformly heat the steel plate 2.

Further, when the desired temperature of the steel plate 2 is high, it is preferable to arrange two or more burner rows E. In this case, an interval L between the burner rows E is preferably in a range of (17 to 300)×Q^{(1/2)} mm, and is more preferably in a range of (17 to 68)×Q^{(1/2)} mm or in a range of (100 to 300)×Q^{(1/2)} mm. For example, if the combustion amount is 35 Meal/h, it is more preferable to set the interval L in a range of approximately 100 to 400 mm or 600 to 1,800 mm.

When the interval L between the burner rows E is shorter than 17×Q^{(1/2)} mm, the local combustion amount increases and the possibility of damaging the burners 5 and the heating chamber 4 increases. Further, when the interval L between the burner rows E is longer than 68×Q^{(1/2)} mm and shorter than 100×Q^{(1/2)} mm, the flame D formed by the burner 5 in a rear row (burner row E₂ in FIG. 4) interferes with the flame D formed by the burner 5 in a front row (burner row E₁ in FIG. 4) to enter a state in which the flame D is separated from the surface 2a of the steel plate 2, and the heat transfer efficiency is lowered. Furthermore, when the interval L between the burner rows E is made longer than 300×Q^{(1/2)} mm, the heating chamber 4 becomes large and heat loss of the furnace body increases, which is therefore not practical.

In addition, in the case where two or more burner rows E are arranged, it is preferable to arrange them alternately. By arranging them in this mariner, it is possible to heat the steel plate 2 more uniformly.

Further, the combustion amount per burner 5 is preferably in a range of 10 to 100 Mcal/h, and more preferably in a range of 20 to 80 Mcal/h, When the combustion amount is less than 10 Mcal/h, since the flame length becomes short, the flame temperature at the time of colliding with the steel plate 2 decreases and the flow rate also decreases, so that the heat transfer efficiency is lowered. Furthermore, if it is greater than 100 Mcal/h, it is necessary to increase the distance between the burner 5 and the steel plate 2, so that the heating chamber 4 becomes large, heat loss of the furnace body increases, and the thermal efficiency decreases.

According to the heating device 1 of the present embodiment, since the steel plate 2 is preheated using the exhaust gas C containing the combustion gas of the burners in the preheating chamber 3, the steel plate 2 can be efficiently heated.

Further, in the present embodiment, since an oxidizing agent having an oxygen concentration of 80 vol % or more is used as the oxidizing agent to be supplied to the burners 5, the fuel is rapidly burned, and a high temperature, high speed flame can be formed. Since the flame D collides with the steel plate 2 directly, it is possible to heat the steel plate 2 efficiently and rapidly. In addition, by colliding the high temperature, high speed flame, it is possible to blow away, while burning, the fats and oils adhered to the surface 2a of the steel plate 2 and the organic particles and inorganic particles mixed in the fats and oils, by the high temperature, high speed flame.

### <Heating Method>

Next, a method for heating a steel product according to the present embodiment will be described.

The method for heating a steel product (steel plate according to the present embodiment includes a preheating step for heating the steel plate 2 in the preheating chamber 3 and a heating step for heating the steel plate 2 in the heating chamber 4 connected to the preheating chamber 3.

For describing the preheating step, first, as shown FIG. 1, the steel plate 2 which is a steel product formed by cold rolling is introduced into the preheating chamber 3 from the steel plate inlet 8, and the steel plate 2 is moved sequentially along the X direction toward the heating chamber 4 side.

In the preheating chamber 3, the exhaust gas C containing the combustion gas of the burner 5 is introduced from the heating chamber 3 by the exhaust gas discharge unit 7. and the steel plate 2 is preheated by the heat exchange between the exhaust gas C and the steel plate 2.

The exhaust gas C that has already exchanged heat with the steel plate 2 is discharged to the outside of the heating device 1 through the exhaust gas discharge pipe 6 by the exhaust gas discharge unit 7.

The steel plate 2 that has completed the heat exchange in the preheating chamber 3 moves into the heating chamber 4, and the heating step is performed in the heating chamber 4.

In the heating step, the flame D formed by the burner 5 which is fonned in the heating chamber 4 directly collides with the surface 2a of the steel plate 2, thereby heating tyre steel plate 2 to a desired temperature. At this time, since the fuel and an oxidizing agent having an oxygen concentration of 80 vol % or more are supplied to the burner 5, the flame formed by the burner is a high temperature, high speed flame.

As a fuel to be supplied to the burner 5, for example, (liquefied natural gas) can be mentioned, As the oxidizing agent, for example, pure oxygen may be used, or a mixture of pure oxygen and air at a desired ratio so that the oxygen concentration is 80% or more may be used.

Further, it is preferable to appropriately adjust the flow rates of the oxidizing agent and the fuel so that the flow rate of oxygen contained in the oxidizing agent to be supplied to the burner 5 is in a range of 90to 120% of the flow rate of oxygen necessary for completely burning the fuel to be supplied to the burner.

When the flow rate of oxygen contained in the oxidizing agent to be supplied to the burner 5 is less than 90% of the flow rate of oxygen necessary for completely burning the fuel, there is a disadvantage in that the unburnt gas is discharged to increase the heat loss of exhaust gas, and when it is more than 120%, there is a disadvantage in that the amount of oxidation of the steel plate increases.

In addition, in the heating step, the steel plate 2 is rapidly and uniformly heated to a desired temperature, and also the fats and oils adhered to the surface 2a of the steel plate 2 and the inorganic particles and organic particles mixed in the aforementioned fats and oils are blown away and removed, while being burnt, by the flame D of the burner 5.

The steel plate 2 that has undergone the heating step is taken out of the heating device 1 through the steel plate outlet 9.

According to the heating method of the present embodiment, since the steel plate 2 is preheated using the exhaust gas C containing the combustion gas of the burners in the preheating chamber 3, the steel plate 2 can be efficiently heated.

Further, in the present embodiment, since an oxidizing agent having an oxygen concentration of 80 vol % or more is used as the oxidizing agent to be supplied to the burners 5, the fuel is rapidly burned, and a high temperature, high speed flame can be formed. Since this flame is made to collide directly with the steel plate, it is possible to heat the steel plate 2 efficiently and rapidly. In addition,by colliding the high temperature, high speed flame, it is possible to blow away, while burning, the fats and oils adhered to the surface 2a of the steel plate 2 and the organic particles and inorganic particles mixed in the fats and oils, by the high temperature, high speed flame.

Although the present invention has been described above based on the embodiments, the present invention. is not limited to the above-described embodiments, and various modifications can be made without departing from the gist thereof.

Hereinafter, the present invention will be described with reference to examples. However, the present invention is in no way limited by the following examples.

### EXAMPLE 1

In this example, a heating test of a cold rolled steel plate was performed using a heating device shown in FIG. 1 and FIG. 2.

LNG (flow rate: 3.4 Nm³/h per burner) was used as a fuel to be supplied to burners disposed in a heating chamber, and pure oxygen(flow rate: 8.5 Nm³/h per burner) was used as an oxidizing agent. Therefore, the combustion amount per burner is 35 Mcal/h. Further, the supply amount of the oxidizing agent corresponds to 110% of the flow rate of oxygen necessary for completely burning LNG.

The number of burners was 41 for both the upper side and lower side of the steel plate and was 82 in total. Further, both the burners the upper side and the burners on the lower side of the steel plate were alternately arranged in two rows (21 burners in the front row and 20 burners in the rear rows. The interval between each burner was 60 mm and the interval between the burner rows was 200 mm.

Further, the distance from the burner to the steel plate was 200 mm and the angle formed between the central axis of the burner and the surface of the steel plate was set to be 80 degrees in the direction in which the burner flame jetting direction and the steel plate moving direction were opposed.

Furthermore, the cold rolled steel plate had a plate thickness of 0.4 mm, a plate width of 1,250 mm, and a moving speed of 200 m/min. The temperature of the steel plate at the steel plate inlet of the heating device was 25° C., the amount of steel plate being processed was 47 T /hour, and the heating time in the heating chamber was 0.3 seconds.

The steel plate temperature was measured using a radiation thermometer so as to measure the temperature distribution in the width direction (the direction perpendicular to the moving direction X of the steel plate) of the steel plate having a plate width of 1,250 mm. The average temperature is a value obtained by averaging the temperature distribution in the width direction of the steel plate.

It was confirmed that the steel plate at 25° C. could be rapidly heated to 400° C. according to the conditions in this example. In addition, the temperature distribution in the width direction (direction perpendicular to the moving direction) of the steel plate was in the range of ±2.6° C. with respect to the average temperature, and it was confirmed that uniform heating was possible.

### EXAMPLE 2

In Example 2, a heating test of a cold rolled steel plate was carried out by changing the burner interval using the heating device shown in FIG. 1.

Table 1 shows the conditions of fuel and oxygen supplied to the burner of the steel plate heating device, and the number of burners. They wereset so that the combustion amounts of all the burners are substantially equal. Other conditions were the same as in Example 1.

TABLE 1

| | | | | | | |
|---|---|---|---|---|---|---|
| Burner interval | [mm] | 40 | 60 | 100 | 120 | 150 |
| Burner | LNG [Nm³/h | 2.3 | 3.4 | 5.6 | 6.6 | 8.2 |
| condition | per burner] | | | | | |
| | O₂ [Nm³/h | 5.8 | 8.5 | 14.1 | 16.8 | 20.7 |
| | per burner] | | | | | |
| Number of | [Number] | 122 | 82 | 50 | 42 | 34 |
| burners | | ((31 +30) | ((21 + 20) | ((13 + 12) | ((11 + 10) | ((9 + 8) |
| | | burners for | burners for | burners for | burners for | burners for |
| | | both upper | both upper | both upper | both upper | both upper |
| | | and lower | and lower | and lower | and lower | and lower |
| | | sides) | sides) | sides) | sides) | sides) |

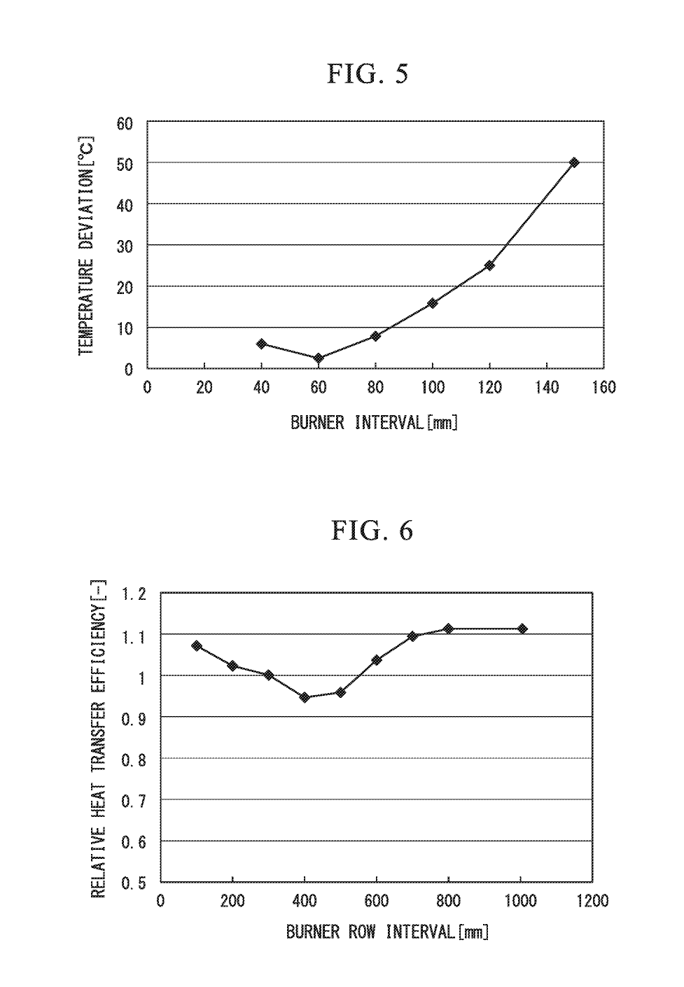

FIG. 5 shows the temperature deviation of the steel plate temperature at each point in the width direction of the steel plate with respect to the burner interval. From the results of this example, it can be seen that when the burner interval is widened, the temperature deviation in the width direction of the steel plate becomes large, which makes uniform heating difficult. This result shows that about 60 mm is appropriate.

### EXAMPLE 3

Under the conditions of Example 1, the influence on the heat ansfer efficiency of the steel plate was confirmed by changing the distance between the burner rows.

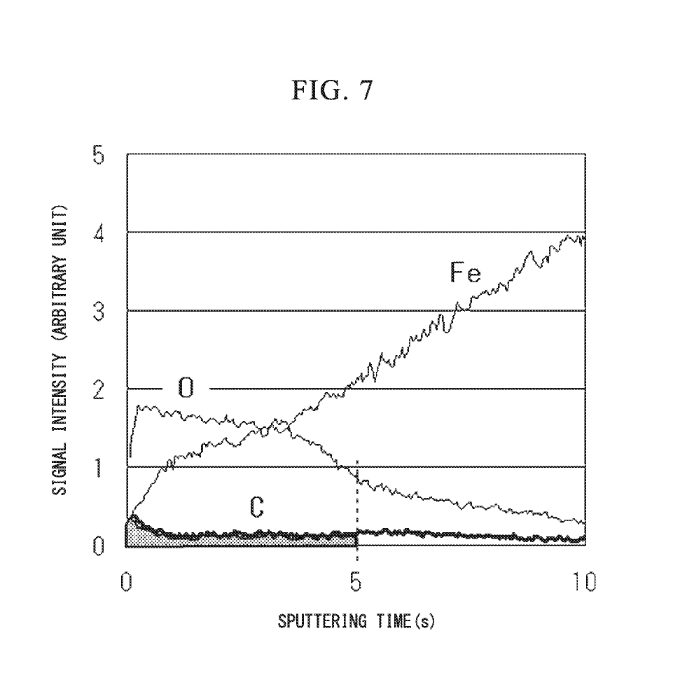

Conditions other than the burner row interval were the same as in Example 1. FIG. 6 shows the influence on the heat transfer efficiency with respect to the burner row interval. The heat transfer efficiency is indicated by a relative heat transfer efficiency by assuming a heat transfer efficiency of 1.0 under the condition of a burner row interval of 300 mm.

From the results of this example, it can be seen that since the relative heat transfer efficiency tends to show the minimum value when the burner row interval is from 400 to 500 mm, it is preferable to set the burner interval between 100 and 300 mm, or to 600 mm or more.

### EXAMPLE 4

In this example, a degreasing test for burning and removing the fats and oils adhered to the surface of the cold rolled steel plate was carried out by the following procedure in accordance with the method for heating a steel product according to the present invention.

LNG was used as a fuel to he supplied to the burners disposed in the heating chamber, and pure oxygen was used as an oxidizing agent. The fuel and oxidizing agent supplied to one burner were LNG (flow rate: 3.4 Nm³/h per burner) and pure oxygen (flow rate: 8.5 Nm³/h per burner), respectively, and the How rate of pure oxygen was set to be 110% of the amount required to completely burning the fuel.

A total of 11 burners were arranged in the same manner as depicted in FIG. 4, that is, burners in the front row E₁ and 6 burners in the rear row E₂. In addition, the burner height H was 200 mm, the burner angle α was 70°, and the burner interval d and the burner row interval L were set differently for each test number. Note that the burners were installed only on the upper side of the steel plate.

As the steel plate 2, a cold rolled steel plate having a plate width of 600 mm and a plate thickness of 0.6 mm was prepared. The burner was burned at various combustion loads and the flame of the burner was caused to directly collide with the surface of the steel plate while traveling the prepared cold rolled steel plate in the X direction in FIG. 1 at various moving speeds so that the fats and oils adhered onto the surface of the cold rolled steel plate were burned and removed. Table 2 shows the combustion conditions of the burner and the moving speed of the cold rolled steel plate.

TABLE 2

| | Burner | Burner row | Combustion | Steel plate |
|---|---|---|---|---|
| Test | interval d | interval L | load | moving speed |
| No. | (mm) | (mm) | (%) | (mm/s) |
| 1 | 40 | 200 | 40 | 130 |
| 2 | | | 70 | 220 |
| 3 | | | 100 | 280 |
| 4 | 60 | | 40 | 90 |
| 5 | | | 70 | 180 |
| 6 | | | 100 | 240 |
| 7 | | 400 | 100 | 210 |
| 8 | | 600 | | 240 |
| 9 | | 800 | | 270 |
| 10 | 80 | 200 | 40 | 90 |
| 11 | | | 70 | 170 |
| 12 | | | 100 | 220 |
| 13 | 100 | | 40 | 80 |
| 14 | | | 70 | 150 |
| 15 | | | 100 | 200 |

Using the cold rolled steel plate after the degreasing test, the removability by burning of fats and oils was evaluated in the following manner.

From each of the cold rolled steel plates after the degreasing test, samples from 7 to 13 places centered around the plate width center were collected to prepare degreased test pieces. The number and position of the collected samples were set as shown in Table 3 in accordance with the burner interval d.

TABLE 3

| Burner | Number of | |
|---|---|---|
| interval d | collected | Collected positions |
| (mm) | samples | (plate width center reference, mm) |
| 40 | 7 | −30, −20, −10, 0, 10, 20, 30 |
| 60 | 9 | −40, −30, −20, −10, 0, 10, 20, 30, 40 |
| 80 | 11 | −50, −40, −30, −20, −10, 0, 10, |
| | | 20, 30, 40, 50 |
| 100 | 13 | −60, −50, −40, −30, −20, −10, 0, 10, 20, |
| | | 30, 40, 50, 60 |

For each of the degreased test pieces collected, element distribution analysis in the depth direction by argon ion sputtering was performed from the surface of the cold rolled steel plate by using a glow discharge spectrometer for surface analysis (CMS). An example of the results is shown in FIG. 7. Among them, by integrating the signal intensity of carbon (C) from the surface to the depth corresponding to seconds of argon ion sputtering, the integrated value was taken as the amount of carbon adhering to the surface layer. The amount of carbon of each of the degreased test pieces collected from 7 to 13 places in the plate width direction was averaged, and this was taken as the residual carbon amount to evaluate the removability by burning of fats and oils based on the magnitude thereof. The evaluation results are shown in Table 4.

The comparative material in Table 4 is obtained as a result of degreasing the cold rolled steel plate with acetone and determining the residual carbon amount using degreased test pieces collected from 7 places.

TABLE 4

| Test No. | Amount of remaining carbon |
|---|---|
| 1 | 0.4 |
| 7 | 0.5 |
| 3 | 0.5 |
| 4 | 0.3 |
| 5 | 0.7 |
| 6 | 0.3 |
| 7 | 0.4 |
| 8 | 0.3 |
| 9 | 0.5 |
| 10 | 0.3 |
| 11 | 0.3 |
| 12 | 0.3 |
| 13 | 0.4 |
| 14 | 0.3 |
| 15 | 0.2 |
| Comparative material | 0.3 |

The residual carbon amount of the comparative material was 0.3, whereas the residual carbon amount of Test Nos. 1 to 15 was from 0.3 to 0.5, and was 0.7 at most. In other words, it was possible to reduce the residual carbon amount to almost the same level as the residual carbon amount of the comparative maters 1. From this result, it was confirmed that it is possible to burn and remove the fats and oils adhered to the surface of the steelproduct to a degree equivalent to that achieved by alkaline degreasing by using the heating method of the present invention. In addition, it was also confirmed that even under various conditions of burner intervals d, burner row intervals L, combustion loads and steel plate moving speeds, it is possible to burn and remove the, fats and oils adhered to the surface of the steel product.

In order to grasp the amount of oxidation of the steel plate, element distribution analysis in the depth direction of carbon (C) by argon ion sputtering from the surface of each steel plate was carried out by using a glow discharge spectrometer for surface analysis GDS). The depth from the surface of the steel plate where carbon was present was treated as the thickness of the oxide film present on the surface of the steel plate.

As a result, with respect to degreased test pieces Nos. 1 to 15, the thicknesses of the oxide films on the surface f the steel plate were all about 0.1 μm, which was equivalent to that of the comparative material.

### INDUSTRIAL APPLICABILITY

It is possible to provide a device for heating a steel product and a method for heating a steel product that can efficiently and rapidly heat a steel product manufactured by cold rolling and can also remove adhered fats and oils.

### REFERENCE SIGNS LIST

1: Heating device;

2: Steel plate;

2a: Surface of steel plate;

3: Preheating chamber;

4: Heating chamber;

5: Burner;

6: Exhaust gas discharge pipe;

7: Exhaust gas discharge unit;

8: Steel plate inlet;

9: Steel plate outlet;

A: Preheating portion;

B: Heating portion;

C: Exhaust gas;

D: Flame;

F: Burner row

1. A device for heating a steel product which is formed by cold rolling, the device comprising:
a preheating chamber for preheating said steel product;
a heating chamber for heating said steel product to a desired temperature which is connected to said preheating chamber;
a plurality of burners arranged so as to sandwich said steel product from above and below in said heating chamber; and
an exhaust gas discharge unit for discharging an exhaust gas containing combustion gas in said burners to the outside of said heating device after being flown into said preheating chamber,
wherein said burners form flames with a fuel and an oxidizing agent having an oxygen concentration of 80 vol % or more, and have a function of blowing away, while burning, at least one of fats and oils adhered onto a surface of said steel product and inorganic particles and organic particles mixed in said fats and oils by said flames, and
said preheating chamber has a structure for preheating said steel product by an exhaust gas containing combustion gas in said burners which has been made to flow thereinto by said exhaust gas discharge unit.

2. The device for heating a steel product according to claim 1,
wherein when a combustion amount per one of said burners is Q [Mcal/h], a distance H between a tip of said burner and said steel product is set in a range from (30 to 110)×Q^{(1/3)} mm, and
an angle α formed between the central axis of said burner and the surface of said steel product is set in a range of 60 to 90 degrees.

3. The device for heating a steel product according to claim 1,
wherein a plurality of said burners on an upper side of said steel product and/or said burners on a lower side of said steel product are arranged in one row, and
when a combustion amount per one of said burners is Q [Mcal/h], an interval d between the plurality of said burners arranged in said one row is in a range of (7 to 20)×Q^{(1/2)} mm.

4. The device for heating a steel product according to claim 1,
wherein said burners on an upper side of said steel product and/or said burners on a lower side of said steel product are arranged so as to form two or more burner rows, and
when a combustion amount per one of said burners is Q [Mcal/h], an interval L between said burner rows is in a range of (17 to 300)×Q^{(1/2)} mm.

5. The device for heating a steel product according to claim 14,
wherein said interval L between said burner rows is set to a range of (17 to 68)×Q^{(1/2)} mm or a range of (100 to 300)×Q^{(1/2)} mm.

6. The device for heating a steel product according to claim 4, wherein said burners arranged to form two or more burner rows are alternately arranged.

7. A method for heating a steel product which is formed by cold rolling
where said steel product is heated in a preheating chamber, then introduced into a heating chamber connected to said preheating chamber and heated to a desired temperature, wherein
a plurality of burners arranged so as to sandwich said steel product from above and below are provided in said heating chamber,
said steel product is heated by causing flames formed by said burners using a fuel and an oxidizing agent having an oxygen concentration of 80 vol % or more to directly collide with a surface of said steel product, and at the same time at least one of fats and oils adhered onto a surface of said steel product and inorganic particles and organic particles mixed in said fats and oils is blown away, while being burnt, by said flames, and
an exhaust gas containing the combustion gas in said burners is introduced into said preheating chamber, thereby exchanging heat with said steel product.

8. The method for heating a steel product according to claim 7,
wherein a flow rate of said oxidizing agent supplied to said burner is in a range of 90 to 120% of a flow rate of oxygen necessary for completely burning said fuel.

9. The method for heating a steel product according to claim 7,
wherein when a combustion amount per one of said burners is Q [Mcal/h], a distance H between a tip of said burner and said steel product is set in a range from (30 to 100)×Q^{(1/3)} mm, and
an angle α formed between the central axis of said burner and the surface of said steel product is set in a range of 60 to 90 degrees.

10. The method for heating a steel product according to claim 7,
wherein a plurality of said burners on an upper side of said steel product and/or said burners on a lower side of said steel product are arranged in one row, and
when a combustion amount per one of said burners is Q [Mcal/h], an interval d between the plurality of said burners arranged in said one row is in a range of (7 to 20)×Q^{(1/2)} mm.

11. The method for heating a steel product according to claim 7,
wherein said burners on an upper side of said steel product and/or said burners on a lower side of said steel product are arranged so as to form two or more burner rows, and
when a combustion amount per one of said burners is Q [Mcal/h], an interval L between said burner rows is in a range of (17 to 300)×Q^{(1/2)} mm.

12. The method for heating a steel product according to claim 11,
wherein said interval L between said burner rows is set to a range of (17 to 68)×Q^{(1/2)} mm or a range of (100 to 300)×Q^{(1/2)} mm.

13. The method for heating a steel product according to claim 7, wherein the combustion amount per one of said burners is in a range of 10 to 100 Mcal/h.

14. The device for heating a steel product according to claim 3, wherein said burners on an upper side of said steel product and/or said burners on a lower side of said steel product are arranged so as to form two or more burner rows, and
when a combustion amount per one of said burners is Q [Mcal/h], an interval L between said burner rows is in a range of (17 to 300)×Q^{(1/2)} mm.

15. The method of heating a steel product according to claim 10,
wherein said burners on an upper side of said steel products and/or said burners on a lower side of said steel product are arranged so as to form two or more burner rows, and
when a combustion amount per one of said burners is Q [Mcal/h], an interval L between said burner rows is in a range of (17 to 300)×Q^{(1/2)} mm. ²
